(19) United States
(12) Patent Application Publication
(10) Pub. No.: US 2016/0297038 A1
(43) Pub. Date: Oct. 13, 2016

(54) Remote Depressurization System for High Pressure Compartment in a Subterranean Tool

(71) Applicant: BAKER HUGHES INCORPORATED, Houston, TX (US)

(72) Inventors: Parry B. Hillis, Spring, TX (US); Kent S. Meyer, Tomball, TX (US)

(73) Assignee: BAKER HUGHES INCORPORATED, Houston, TX (US)

(21) Appl. No.: 14/683,296

(22) Filed: Apr. 10, 2015

(51) Int. Cl. B23P 6/00

(52) U.S. Cl. CPC B23P 6/00

(57) ABSTRACT

A subterranean tool that has a pressurized chamber when brought out of the hole after being actuated is depressurized by a tool that facilitates location of a technician at a distance when the gas is allowed to escape. Preferably, the tool features a hydraulic system with a device to build pressure at the technician end and a suitably long hydraulic line to the subterranean tool to connect to the venting tool that is independently secured to the subterranean tool to be depressurized. Raising the hydraulic pressure in the system extends a piston in the venting tool against a rupture disc to cause the disc to fail and the pressurized gas to escape. The vent tool is secured against longitudinal or relative rotational movement with respect to the subterranean tool. Variations including pneumatic or electrically or magnetically driven pistons, among other variants are also contemplated.

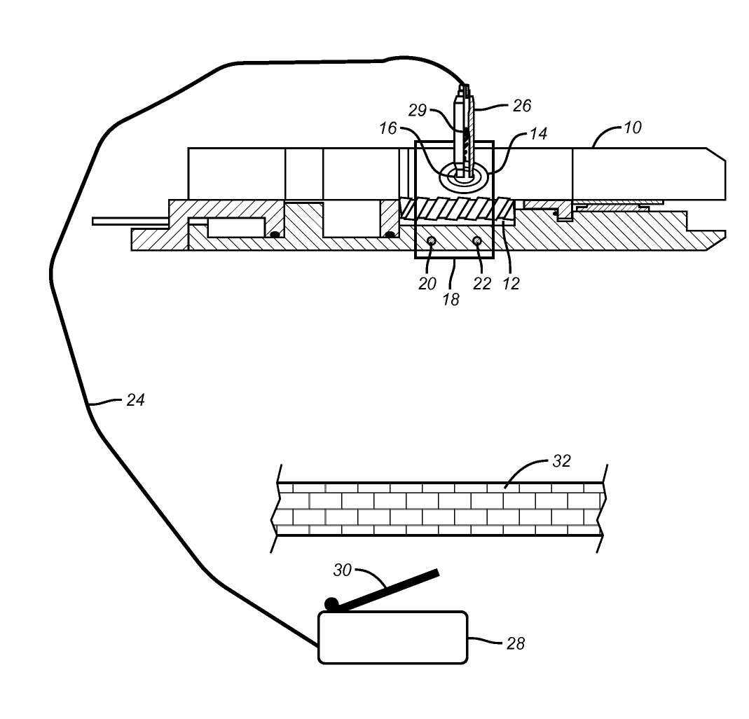

### FIELD OF THE INVENTION

The field of the invention is subterranean tools that are removed to the surface after use with a pressurized chamber that needs to be vented for tool disassembly prior to redressing the tool after use.

### BACKGROUND OF THE INVENTION

Exploration and production of oil and gas has many potential dangers and personnel safety is a very important issue every single day. Some tools are configured with charged gas chambers as a potential energy source for subsequent operation at a subterranean location. When those tools come out of the hole the chamber can still have as much as 700 PSIG or more. The chamber needs to be depressurized so that the tool can be assembled and spent parts such as shear pins replaced as the tool is made ready for another use in a different or the same hole. U.S. Pat. No. 5,845,669 illustrates a tool that can be secured to the pressurized compartment where there is a vent port covered by a rupture disc. A technician stands close by as the bolt is advanced with a tool into the rupture disc to break the disc. At this point the very high pressure escapes with the technician close at hand. This is not desirable. First is the high velocity of the escaping gas that could also take with it parts of the now ruptured rupture disc. Another hazard of rapidly escaping gas is the high decibel level of the ensuing noise from a high velocity gas release that follows breaking the rupture disc.

The present invention seeks to address these issues by allowing the venting operation to occur in a shop or in the field under conditions where the technician can stand clear of the tool when the rupture disc is broken. The device is an actuation system that is preferably hydraulic to advance a piston onto the disc from a remote location. The technician can stand away from the source of noise and high velocity gas, preferably behind a wall or some other shelter. The vent tool is secured to the subterranean tool against any movement before actuation. After the pressure is fully relieved, the tool is disconnected. These and other aspects of the present invention will be more readily apparent to those skilled in the art from a review of the detailed description of the preferred embodiment and the associated drawing while recognizing that the full scope of the invention is to be determined by the appended claims.

### SUMMARY OF THE INVENTION

A subterranean tool that has a pressurized chamber when brought out of the hole after being actuated is depressurized by a tool that facilitates location of a technician at a distance when the gas is allowed to escape. Preferably, the tool features a hydraulic system with a device to build pressure at the technician end and a suitably long hydraulic line to the subterranean tool to connect to the venting tool that is independently secured to the subterranean tool to be depressurized. Raising the hydraulic pressure in the system extends a piston in the venting tool against a rupture disc to cause the disc to fail and the pressurized gas to escape. The vent tool is secured against longitudinal or relative rotational movement with respect to the subterranean tool. Variations including pneumatic or electrically or magnetically driven pistons, among other variants are also contemplated.

### BRIEF DESCRIPTION OF THE DRAWING

The FIGURE illustrates a hydraulic solution to remote venting a pressurized compartment in a subterranean tool by a technician after the tool is deployed and before the tool is redressed for a subsequent use.

### DETAILED DESCRIPTION OF THE PREFERRED EMBODIMENT

The subterranean tool 10 has a pressurized compartment 12 when retrieved out of a wellbore after use. The compartment 12 has an outlet 14 closed off with a rupture disc 16. The pressure venting tool 18 is schematically represented by a rectangle. It has hardware and fixation pins 20 and 22 that go into exterior holes in the tool 10 for fixation of the venting tool 18 to the subterranean tool 10. Those same exterior holes that are not shown are used in assembly of tool 10 to insert a wrench to assemble parts together with relative rotation.

A hydraulic line 24 connects a piston housing 26 to a pressure building device 28. Preferably the line length is long enough to allow the technician to stand behind a nearby wall for protection from noise, high velocity gas stream or any fragment propelled by the high velocity gas stream. In most shops a length of about 10 meters should be more than adequate for reaching a remote location for the technician. The piston housing 26 has an internal piston 29 with a sharp leading end designed to penetrate the rupture disc 16 to vent pressurized gas. The device 28 can be a well-known device akin to those used to jack up cars that with a repetitive motion of the handle 30 builds pressure in line 24. As the operator is pumping the handle 30 he or she can stand behind a wall 32 to keep out of harm's way as the pressure is released. The wall also reduces the noise associated with the gas release, but a prudent technician would also be wearing ear plugs for noise protection.

There are variations that are contemplated by the present invention. The device 28 can be a pressurized pneumatic line such as from a system air compressor that is available in most mechanical shops. Alternatively the piston 29 can be driven by a stepper motor with device 28 being the control for actuation of the stepper motor or some other electrically actuated device such as a solenoid that releases a potential energy force such as a spring. Alternatively a motor can operate a threaded shaft that advances axially on rotational input from the motor that is enabled by a device such as 28. The motor in the latter case can be electrically driven or fluid driven such as hydraulically, pneumatically, with a magnetic or other type of force field or with steam if available.

In essence the venting procedure separates the technician from the hazard at the time of the gas release. The tool can then be redressed after its pressurized compartment is vented to atmospheric pressure. While there are many ways to trigger the gas venting some of which involve breaking a rupture disc, the fluid retention device can also be a one way valve such as a spring loaded ball that is pushed off its seat with movement of the piston 29. The technician can get far enough away from the venting location to avoid hearing damage and the high velocity gas stream which could directly or indirectly by propelling an object cause the technician serious personal injury.

The above description is illustrative of the preferred embodiment and many modifications may be made by those skilled in the art without departing from the invention whose scope is to be determined from the literal and equivalent scope of the claims below:

We claim:

1. A servicing method for a subterranean tool after use downhole and prior to disassembly, comprising:
mounting a venting device to the subterranean tool;
positioning an actuator for said venting device at a remote location from the subterranean tool;
opening a vent passage from a pressurized compartment of the subterranean tool with said actuator triggering said venting device;
venting gas from the subterranean tool before disassembly.

2. The method of claim 1, comprising:
accomplishing said opening with the breaking of a rupture disc.

3. The method of claim 1, comprising:
accomplishing said opening with overcoming a one way valve.

4. The method of claim 1, comprising:
moving a piston to accomplish said opening.

5. The method of claim 5, comprising:
driving said piston hydraulically or with steam.

6. The method of claim 5, comprising:
driving said piston pneumatically.

7. The method of claim 5, comprising:
driving said piston electrically or with a field.

8. The method of claim 7, comprising:
using an electric motor to drive said piston.

9. The method of claim 1, comprising:
securely mounting said venting device to the subterranean tool against relative movement.

10. The method of claim 9, comprising:
preventing said venting device from sliding along the subterranean tool or rotating with respect to the subterranean tool.

11. The method of claim 1, comprising:
positioning said actuator behind a wall to protect a technician from noise, gas velocity or venting gas propelled objects.

12. The method of claim 10, comprising:
inserting at least one member on said venting device into at least one exterior recess on the subterranean tool to accomplish said preventing.

13. The method of claim 2, comprising:
moving a piston to accomplish said opening.

14. The method of claim 13, comprising:
driving said piston hydraulically or with steam.

15. The method of claim 14, comprising:
securely mounting said venting device to the subterranean tool against relative movement.

16. The method of claim 15, comprising:
preventing said venting device from sliding along the subterranean tool or rotating with respect to the subterranean tool.

17. The method of claim 16, comprising:
positioning said actuator behind a wall to protect a technician from noise, gas velocity or venting gas propelled objects.
